(19) United States
(12) Patent Application Publication
(10) Pub. No.: US 2013/0321198 A1
(43) Pub. Date: Dec. 5, 2013

(54) MIMO RADAR SYSTEM HAVING MULTIPLE TRANSMITTERS AND RECEIVERS

(71) Applicant: ELECTRONICS AND TELECOMMUNICATIONS RESEARCH INSTITUTE, Daejeon (KR)

(72) Inventors: Pil Jae PARK, Daejeon (KR); Cheon Soo Kim, Daejeon (KR); Hyun Kyu Yu, Daejeon (KR)

(73) Assignee: Electronics and Telecommunications Research Institute, Daejeon (KR)

(21) Appl. No.: 13/759,333

(22) Filed: Feb. 5, 2013

(30) Foreign Application Priority Data
May 31, 2012 (KR) 10-2012-0058672

(51) Int. Cl. G01S 13/02

(52) U.S. Cl. CPC G01S 13/02
USPC 342/175

(57) ABSTRACT

A MIMO radar system includes one or more receivers and transmitters. Any one of the one or more transmitters provides a reference signal for injection-locking. The MIMO radar system generates multiple signals having phase and frequency which are injection-locked to those of the reference signal.

### RELATED APPLICATION(S)

This application claims the benefit of Korean Patent Application No. 10-2012-0058672, filed on May 31, 2012, which is hereby incorporated by reference as if fully set forth herein.

### FIELD OF THE INVENTION

The present invention relates to a radar system, and more particularly, to a multiple-input multiple-output (MIMO) radar system having multiple transmitters and receivers that uses injection-lock technique.

### BACKGROUND OF THE INVENTION

A radar technology is a sensor technology to detect and obtain a relative position and speed information of targets. For that, a radar system transmits electromagnetic waves to targets and receives bounce-off echo signals from the targets. The radar system includes a transmitter that generates electromagnetic waves, a receiver that receives bounce-off echo signals returned from targets, and a signal processor that processes the received echo signals. The radar system performance can be enhanced by having multiple transmitters and receivers that improve directivity with respect to a target. In the radar system having such a configuration, it is important to distribute a reference signal. To this end, a multi-input multi-output (MIMO) radar system has been suggested in the art, which will be described with reference to the accompanying drawings.

FIG. 4 is a diagram illustrating a MIMO radar system in accordance with a related art.

As illustrated in FIG. 4, the MIMO radar system transmits signals 14 and 16 generated from plural transmitters to a target 50 via antennas 10 and 12. The transmitted signals 14 and 16 bounce off the target 50 to become an echo signal 18 so as to be received through a receiving antenna 20 of a multi-receiver including one or more receivers. The echo signal 18 is processed by a signal processor (not shown) to recognize and track the target 50. The multi-receiver employs a phased array structure that has phase variation among the receivers. As a result, the phased array receiver has directivity. Thus, the system performance may be improved with the increased gain of the phased array receiver.

This MIMO radar system commonly employs a power divider to distribute a signal source required for multiple transmission and reception thereof. For example, the MIMO radar system employs a single signal source to distribute the signal source for the operation of the MIMO radar system by using a phase locked loop (PLL) 54 and Wilkinson power dividers 52 as illustrated in FIG. 5. In this case, a chip area and power consumption are increased due to the arrangement of multiple passive devices such as the power dividers 52 and the like. Specifically, since the power dividers accompany a power loss, buffer amplifiers 22 and 24 are used for amplifying a signal source in order to recover the power loss, as shown in FIG. 4. This disadvantageously increases power consumption in implementing the radar system. In FIG. 4, reference numerals 404 and 414 denote a power amplifier; a reference numeral 424 denotes a low noise amplifier; and a reference numeral 426 denotes a frequency down-converter.

In particular, a chip area and power consumption are very critical when the MIMO radar system is implemented in an integrated circuit. Further, there is a limitation in implementing a small area and low power radar according to the conventional design scheme. The reason is because the power dividers and the buffer amplifiers should be implemented in order to distribute a signal source.

### SUMMARY OF THE INVENTION

In view of the above, therefore, the present invention provides a MIMO radar system with multiple transmitters and receivers for generating signals required for the transmitters and receivers, which enables the design to be highly integrated, to have a small size, and to consume less power.

In accordance with the present invention, there is provided a multiple-input multiple-output (MIMO) radar system, which includes: one or more receivers and transmitters, wherein any one of the one or more transmitters is configured to provide a reference signal for injection-locking, wherein the MIMO radar system generates multiple signals having phase and frequency which are injection-locked to those of the reference signal.

Preferably, the any one of the one or more transmitters includes a signal generator to generate the reference signal, and the reference signal includes a signal having specific phase and frequency and is provided to the one or more receivers and the other transmitter.

Preferably, each of the receivers includes: a signal generator configured to generate a local signal having phase and frequency that are injection-locked to those of the reference signal.

Preferably, the other transmitter includes a signal generator configured to generate a transmission signal having frequency and phase that are injection-locked to those of the reference signal.

Preferably, the signal generator includes a VCO.

Preferably, the signal generator of the receiver is a voltage controlled oscillator (VCO) to receive the reference signal.

Preferably, the signal generator of the any one of the one or more transistors is a voltage controlled oscillator (VCO), and the reference signal is generated by the VCO using a phase locked loop (PLL) for controlling the reference signal to have the specific frequency and phase.

Preferably, each of the VCO of the transmitter and the VCO of the receiver includes: a cross-coupled transistor pair; a resonance tank comprised of an inductor and a capacitor; and a current source of a transistor configured to supply a constant DC current to the VCO.

Preferably, the cross-coupled transistor pair includes CMOS transistors or bipolar transistors.

Preferably, the reference signal includes a frequency modulated continuous wave (FMCW) signal or digital modulation wave signal.

Preferably, the one or more transmitters and receivers are connected by a metal line or a metal line on a printed circuit board (PCB).

Preferably, the frequency of the reference signal is multiplied or divided before being applied to the other transmitter and the one or more receivers.

Preferably, each of the one or more transmitters includes: a VCO configured to generate a carrier of a transmission signal; a frequency up-converter configured to convert a baseband signal into an analog signal whose center frequency is a carrier frequency using the transmission signal; and a power amplifier configured to amplify an output signal from the frequency up-converter to generate the transmission signal.

Preferably, each of the one or more transmitters includes: a VCO configured to generate a transmission signal; a power amplifier configured to amplify the transmission signal; and a transmission antenna configured to transmit the transmission signal amplified by the power amplifier to the outside.

Preferably, each of the one or more receivers includes: a receiving antenna configured to receive an echo signal; an amplifier configured to amplify the echo signal; and a frequency down-converter configured to convert an output signal from the amplifier into a baseband signal.

### BRIEF DESCRIPTION OF THE DRAWINGS

The above and other objects and features of the present invention will become apparent from the following description of embodiments, given in conjunction with the accompanying drawings, in which:

FIG. 1 illustrates a configuration of a MIMO radar system in accordance with an embodiment of the present invention;

FIGS. 2A and 2B are detailed circuit diagrams of a VCO used in the MIMO radar system in accordance with an embodiment of the present invention;

FIG. 3 illustrates a configuration of a MIMO radar system in accordance with another embodiment of the present invention;

FIG. 4 illustrates a configuration of a MIMO radar system in accordance with a related art; and

FIG. 5 is a detailed circuit diagram for generating a signal source in the MIMO radar system in accordance with a related art.

### DETAILED DESCRIPTION OF THE EMBODIMENTS

Hereinafter, embodiments of the present invention will be described in detail with the accompanying drawings.

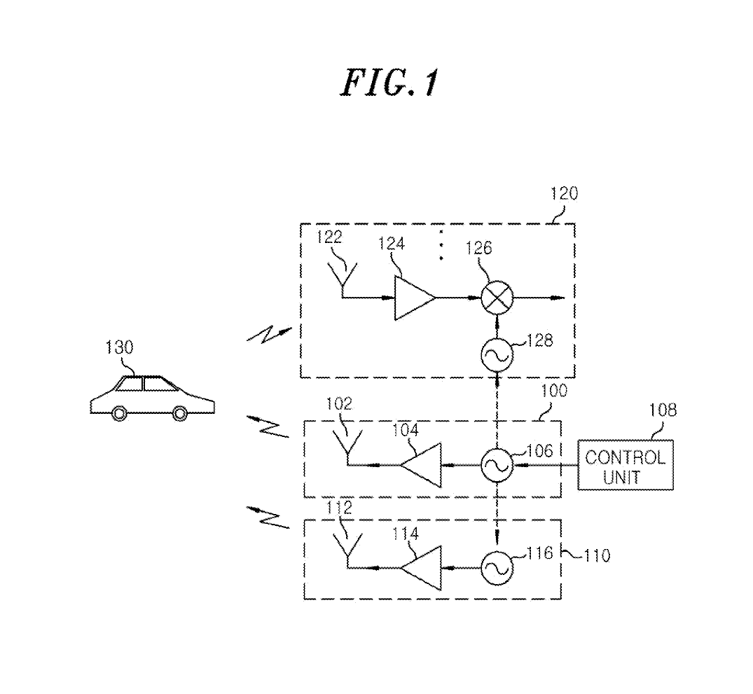

FIG. 1 illustrates a configuration of a MIMO radar system having multiple transmitters and receivers in accordance with an embodiment of the present invention.

As illustrated in FIG. 1, a MIMO radar system includes a plurality of, for example, first and second transmitters 100 and 110, and one or more receivers 120. The MIMO radar system generates multiple signals having particular phase and frequency which are injection-locked to those of a reference signal for injection-locking generated from any one of the first and second transmitters 100 and 110.

In this manner, by employing the multiple transmitters and receivers such as the first and second transmitters 100 and 110 and the receiver 120, the directivity of transmitting and receiving antennas in the MIMO radar system may enhance system performance that detects and tracks multiple targets.

This MIMO radar system transmits transmission signals using first and second transmitters 100 and 110 and subsequently receives an echo signal reflected from a target 130 through the receiver 120.

Meanwhile, as described above, any one of the first and second transmitters 100 and 110 may be used to generate the reference signal. Hereinafter, for the convenience of explanation, the first transmitter 100 will be designated as a reference signal source and the VCO 106 will be referred to as a reference signal generator.

The first transmitter 100 serving as the reference signal source generates a reference signal for injection-locking with specific phase and frequency in accordance with a control signal with controlled frequency and phase. Further, the first transmitter 100 supplies the reference signal to the receiver 120 and the second transmitter 110 to cause them to generate injection-locked signals having phase and frequency to those of the reference signal. To this end, the first transmitter 100 includes an antenna 102 for outputting the reference signal source as a transmission signal to the outside, a power amplifier 104 for amplifying the reference signal to be supplied to the antenna 102, a voltage controlled oscillator (VCO) 106 for generating the reference signal, and a control unit 108 for supplying the control signal to control a phase and a frequency of the reference signal source to the VCO 106.

In the specification, the term of injection-locking refers to obtaining a signal having phase and frequency which are injection-locked to those of the reference signal. Such an injection-locking may be accomplished by having a contact using a wiring or non-contact electromagnetic coupling on the reference signal generator.

Meanwhile, the primary oscillation signal generated from the first transmitter 100 may be a frequency modulated continuous wave (FMCW) signal or may be a signal which has been converted into digital codes including meaningful information, i.e., digital modulation wave.

In addition, the frequency of the reference signal generated from the first transmitter 100 may be multiplied or divided before being supplied to the second transmitter 110 and the receiver 120.

The VCO 106 receives the control signal with controlled phase and frequency from the control unit 108 and generates the reference signal for injection-locking with specific phase and frequency. The VCO 106 provides the reference signal with specific phase and frequency to the second transmitters 110 and a VCO 128 of the receiver 120.

Similar to the first transmitter 100, the second transmitter 110 includes an antenna 112, a power amplifier 114, and a VCO 116. The second transmitter 110 receives the reference signal source generated by the first transmitter 110 and allows an oscillation signal from the VCO 116 to have phase and frequency which are injection-locked to those of the reference signal. Such the injection-locked oscillation signal is then transmitted to the outside as a transmission signal through the power amplifier 114 and the antenna 112.

Further, each of the VCOs 106 and 116 of the first and second transmitters 100 and 110 generate a carrier for the transmission signal. Although not shown, the first and second transmitters 100 and 110 may further include an analog-to-digital converter (ADC) (not shown) for converting a digital modulation signal into an analog signal of a base band.

The receiver 120 includes a receiving antenna 122, a low noise amplifier 124, a frequency down-converter 126, and a VCO 128. The reference signal generated from the first transmitter 100 is received through the VCO 128 of the receiver 120. The VCO 128 generates a local (LO) signal having frequency and phase which are injection-locked to the received reference signal. The injection-locked LO signal is then provided to the frequency down-converter 126. The frequency down-converter 128 down-converts the echo signal received through the receiving antenna 122 by using the LO signal provided from the VCO 128.

More specifically, the receiver 120 amplifies an echo signal received through the receiving antenna 122 while suppressing noise signals using the low noise amplifier 124. The amplified echo signal is then provided to the frequency down-converter 126. The frequency down-converter 126 mixes the amplified echo signal with the injection-locked LO signal to produce a baseband echo signal, which will then be provided to the ADC (not shown). Thus, the ADC may convert the baseband echo signal into a digital echo signal.

The reference signal for injection-locking in accordance with the embodiment may be generated within the VCO 106 of the first transmitter 100 and applied to the VCOs 116 and 128 of the second transmitter 110 and the receiver 120.

Also, the reference signal in accordance with the embodiment may be an output signal of the VCO 106 and applied to the VCOs 116 and 128 of the second transmitter 110 and the receiver 120.

The VCO 106 of the first transmitter 100 and the VCOs 116 and 128 of the second transmitter 110 and the receiver 120 may be connected by a metal line or a metal line on a printed circuit board (PCB).

In accordance with the embodiment as described above, the reference signal generated from the reference signal source is supplied to each VCO of the receiver to generate a local signal having phase and frequency which are injection-locked to those of the reference signal using the injection-locking. Therefore, the radar receiver can be implemented without having any device for power distribution.

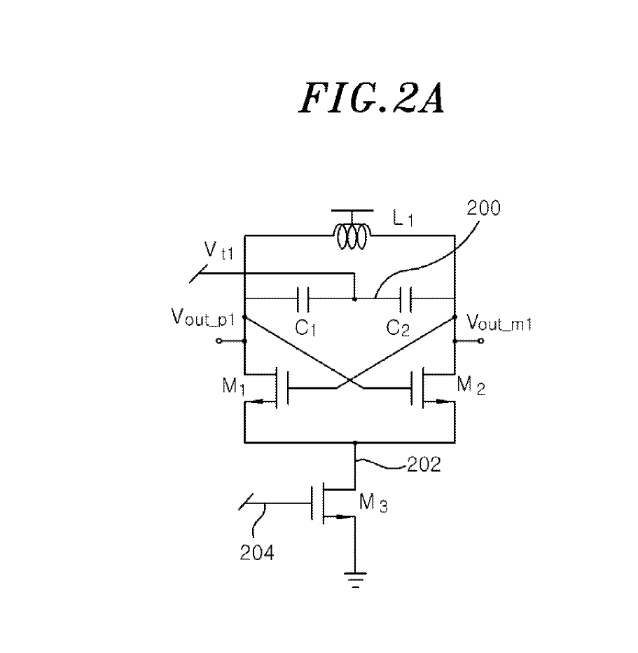

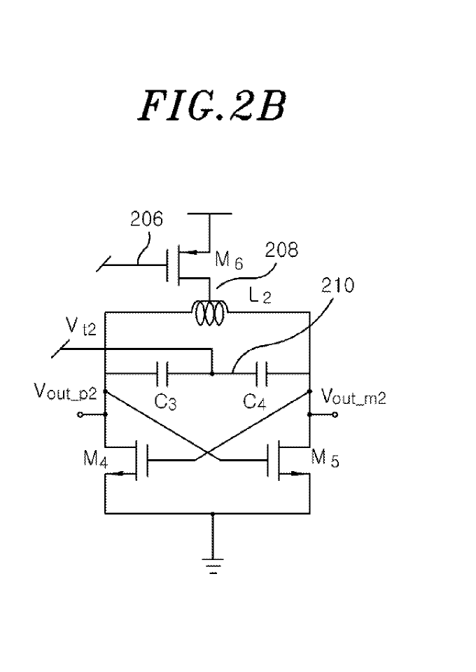

Meanwhile, each of the VCOs 106 and 116 in the first and second transmitters 100 and 110, and the VCO 128 in the receiver 120 may be implemented with CMOS devices or bipolar devices, i.e., CMOS transistors or bipolar transistors, on an integrated circuit, as shown in FIGS. 2A and 2B.

FIGS. 2A and 2B are detailed circuit diagrams of the VCO used in the transmitters and the receiver of the MIMO radar system in accordance with an embodiment of the present invention.

First, referring to FIG. 2A, the VCO may be implemented by a cross-coupled pair of CMOS transistors M1 and M2, a resonance tank composed of an inductor L1 and capacitors C1 and C2, and a current source of CMOS transistor M3 for supplying a constant DC current to the circuit.

On the other hand, referring to FIG. 2B, the VCO may be implemented by a cross-coupled pair of CMOS transistors M4 and M5, a resonance tank composed of an inductor L2 and capacitors C3 and C4, and a current source of transistor M6

As illustrated in FIG. 2A, an oscillation signal from the VCO may be determined by a resonance frequency of the resonance tank, and the resonance frequency may be changed by changing a capacitance value by applying a voltage to a node Vₜ₁. Also, the oscillation signal is output in a differential form to a node of Vₒᵤₜ_{_{—}}ₚ₁ and Vₒᵤₜ_{_{—}}ₘ₁. The differential signal is input to and output from each of nodes 200, 202, and 204 corresponding to a virtual ground. Thus, the VCO may lock an input or output signal using the injection-lock scheme.

In similar manner, as illustrated in FIG. 2B, an oscillation signal from the VCO may be determined by a resonance frequency of the resonance tank, and the resonance frequency may be changed by changing a capacitance value by applying a voltage to a node Vₜ₂. Also, the oscillation signal is output in a differential form to a node of Vₒᵤₜ_{_{—}}ₚ₂ and Vₒᵤₜ_{_{—}}ₘ₂. The differential signal is input to and output from each of nodes 206, 208, and 210 corresponding to a virtual ground. Thus, the VCO may lock an input or output signal using the injection-lock scheme.

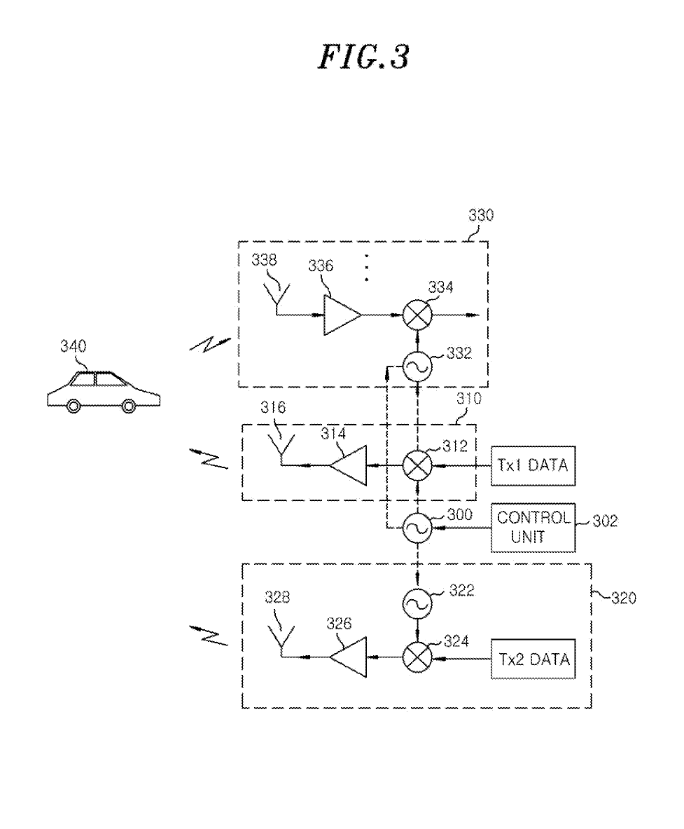

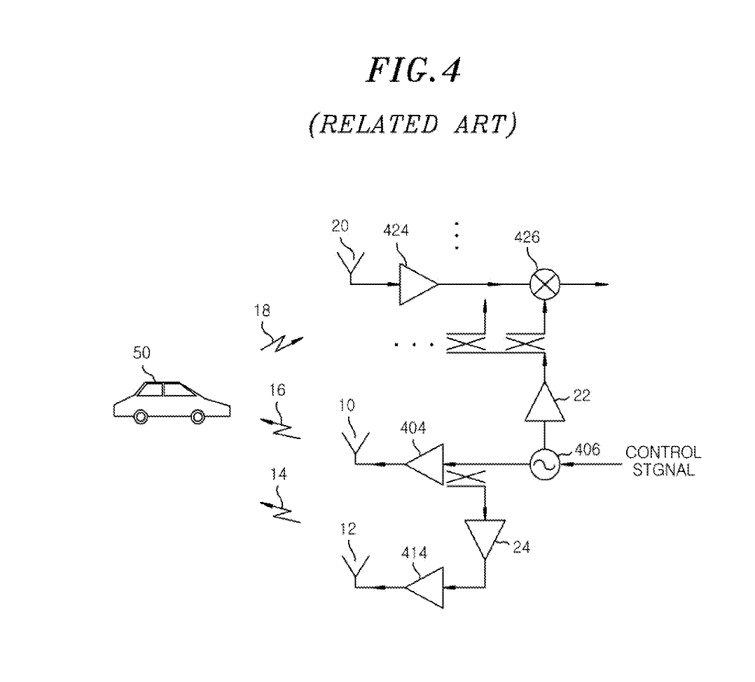

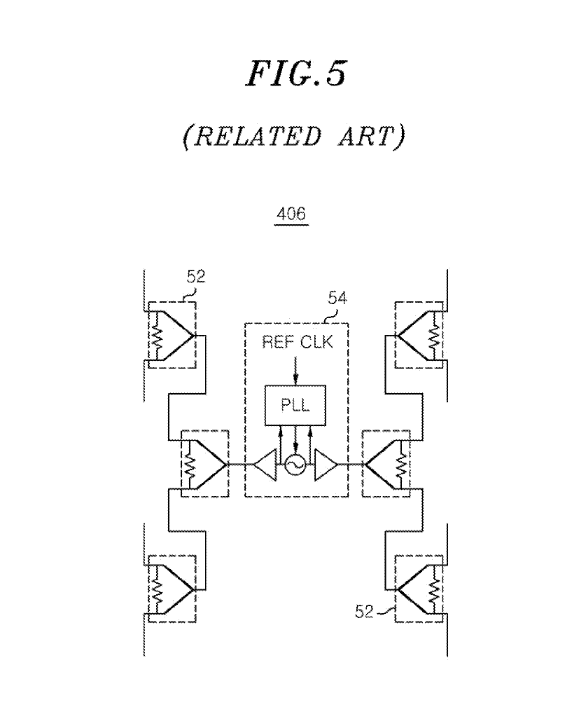

FIG. 3 illustrates a MIMO radar system having multiple transmitters and multiple receivers in accordance with another embodiment of the present invention.

The MIMO radar system includes a VCO 300, a control unit 302, a plurality of, for example, first and second transmitters 310 and 320, and one or more receivers 330.

The VCO 300 generates a reference signal for injection-locking with specific phase and frequency in accordance with a control signal with controlled phase and frequency. The control unit 302 provides the control signal to control a phase and a frequency of an oscillation signal from the VCO 300. In an embodiment, the control unit 302 may be, for example, a phase locked loop (PLL).

More specifically, the VCO 300 generates the reference signal having a specific phase and frequency according to the control signal. The reference signal with specific phase and frequency is then provided to a frequency up-converter 312 of the first transmitter 310 and VCOs 322 and 332 of the second transmitter 320 and the receiver 330.

Also, the VCO 300 generates a carrier for a transmission signal.

The frequency up-converter 312 of the first transmitter 310 up-converts transmission data, Tx1 DATA, using the reference signal provided from the VCO 300, and then outputs the up-converted transmission data to the outside via the power amplifier 314 and the antenna 316. More specifically, the frequency up-converter 312 mixes the transmission data, Tx1 DATA, of a baseband signal with the reference signal to produce an up-converted transmission signal.

Meanwhile, the VCO 322 of the second transmitter 320 generates an LO signal having frequency and phase which are injection-locked to those of the reference signal, and provides the injection-locked LO signal to the frequency up-converter 324. Also, the VCO 322 generates a carrier for the transmission of TX2 data and provides the same to the frequency up-converter 324.

The frequency up-converter 324 of the second transmitter 320 up-converts transmission data, Tx2 DATA, using the injection-locked LO signal provided from the VCO 322, and then outputs up-converted transmission data to the outside via the power amplifier 326 and the antenna 328. More specifically, the frequency up-converter 324 mixes the injection-locked LO signal and the transmission data, Tx2 DATA, of a baseband signal to produce an up-converted transmission signal and provides the up-converted transmission signal to the power amplifier 326.

Meanwhile, in the receiver 330, an echo signal is received through an antenna 338 and is amplified by a low noise amplifier 336. The amplified echo signal is provided to a frequency down-converter 334.

The VCO 332 generates an LO signal having phase and frequency which are injection-locked to those of the reference signal from the VCO 300 and outputs the injection-locked LO signal to the frequency down-converter 334.

The frequency down-converter 334 mixes the amplified echo signal with the injection-locked LO signal to generate a down-converted echo signal.

In other words, the receiver 330 amplifies the echo signal received through the antenna 338 using the low noise amplifier 336 and outputs the amplified echo signal with removed noise signal to the frequency down-converter 334. The frequency down-converter 334 then down-converts the amplified echo signal into a baseband signal, and the baseband signal may be converted into a digital baseband signal by an ADC (not shown) for further processing.

In the MIMO radar system MIMO radar in accordance with the embodiment, the signals required for the transmitter and the receiver is generated using the injection-locking and the MIMO radar system is implemented using the same. Therefore, a chip area may be considerably reduced as compared to the conventional system using a passive power frequency divider, and the chip area may also be considerably reduced as compared to the conventional system using the passive power frequency divider from a single signal source.

Also, the MIMO radar system may be implemented with a chip consuming less power and having a small area by applying the embodiment.

Further, a circuit for implementing multiple signal sources of the conventional radar system may be simplified and metal lines used for distributing the signal sources may be implemented in simplified fashion.

The MIMO radar structure in accordance with the embodiments is appropriately applied to a chip technology, and in particular, an integrated radar system may be implemented by applying an integrated circuit technology including a CMOS technique. It may be designed to be highly integrated and small and consumes less power as compared to an existing compound-based radar chip. In particular, the design of low power consumption may enhance the reliability of a system.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A multiple-input multiple-output (MIMO) radar system comprising:
one or more receivers and transmitters, wherein any one of the one or more transmitters is configured to provide a reference signal for injection-locking,
wherein the MIMO radar system generates multiple signals having phase and frequency which are injection-locked to those of the reference signal.

2. The MIMO radar system of claim 1, wherein the any one of the one or more transmitters comprises a signal generator to generate the reference signal, and
wherein the reference signal comprises a signal having specific phase and frequency and is provided to the one or more receivers and the other transmitter.

3. The MIMO radar system of claim 1, wherein each of the receivers comprises:
a signal generator configured to generate a local signal having phase and frequency that are injection-locked to those of the reference signal.

4. The MIMO radar system of claim 1, wherein the other transmitter comprises a signal generator configured to generate a transmission signal having frequency and phase that are injection-locked to those of the reference signal.

5. The MIMO radar system of claim 4, wherein the signal generator comprises a VCO.

6. The MIMO radar system of claim 3, wherein the signal generator of the receiver is a voltage controlled oscillator (VCO) to receive the reference signal.

7. The MIMO radar system of claim 6, wherein the signal generator of the any one of the one or more transistors is a voltage controlled oscillator (VCO), and the reference signal is generated by the VCO using a phase locked loop (PLL) for controlling the reference signal to have the specific frequency and phase.

8. The MIMO radar system of claim 7, wherein each of the VCO of the transmitter and the VCO of the receiver comprises:
a cross-coupled transistor pair;
a resonance tank comprised of an inductor and a capacitor; and
a current source of a transistor configured to supply a constant DC current to the VCO.

9. The MIMO radar system of claim 8, wherein the cross-coupled transistor pair comprises CMOS transistors or bipolar transistors.

10. The MIMO radar system of claim 1, wherein the reference signal comprises a frequency modulated continuous wave (FMCW) signal or digital modulation wave signal.

11. The MIMO radar system of claim 1, wherein the one or more transmitters and receivers are connected by a metal line or a metal line on a printed circuit board (PCB).

12. The MIMO radar system of claim 1, wherein the frequency of the reference signal is multiplied or divided before being applied to the other transmitter and the one or more receivers.

13. The MIMO radar system of claim 1, wherein each of the one or more transmitters comprises:
a VCO configured to generate a carrier of a transmission signal;
a frequency up-converter configured to convert a baseband signal into an analog signal whose center frequency is a carrier frequency using the transmission signal; and
a power amplifier configured to amplify an output signal from the frequency up-converter to generate the transmission signal.

14. The MIMO radar system of claim 1, wherein each of the one or more transmitters comprises:
a VCO configured to generate a transmission signal;
a power amplifier configured to amplify the transmission signal; and
a transmission antenna configured to transmit the transmission signal amplified by the power amplifier to the outside.

15. The MIMO radar system of claim 1, wherein each of the one or more receivers comprises:
a receiving antenna configured to receive an echo signal;
an amplifier configured to amplify the echo signal; and
a frequency down-converter configured to convert an output signal from the amplifier into a baseband signal.
